(19) United States
(12) Patent Application Publication
(10) Pub. No.: US 2021/0287305 A1
(43) Pub. Date: Sep. 16, 2021

(54) METHOD AND SYSTEM FOR GENERATING SOCIAL MEDIA ENGAGEMENT

(71) Applicant: SYNQ ACCESS + SECURITY TECHNOLOGY LTD., Victoria (CA)

(72) Inventors: Nolan WHEELER, Victoria (CA); Joshua RODRIGUEZ, Victoria (CA); Quintan NEVILLE, Victoria (CA)

(21) Appl. No.: 16/920,543

(22) Filed: Jul. 3, 2020

(30) Foreign Application Priority Data
Mar. 13, 2020 (CA) 3075570

(51) Int. Cl. G06Q 50/00; G06Q 30/02

(52) U.S. Cl. CPC G06Q 50/01; G06Q 20/20; G06Q 30/0203

(57) ABSTRACT

A method and associated system for generating social media engagement. The method involves placing at a brick and mortar business a computing device with a customer interface. Upon a triggering event, the computing device prompts a customer using the customer interface to complete a satisfaction survey. Upon the customer completing the satisfaction survey, the computing device prompting the customer to post to social media and directing the customer to a URL with their interaction with the satisfaction survey pre-populating a social media post.

### FIELD

There is described a method and system for generating social media engagement and, in particular, social media engagement for brick and mortar businesses.

### BACKGROUND

Social media, online reviews and alike have transformed the consumer landscape over the past decade. Traditional brick and mortar businesses have been forced to become involved with a myriad of online strategies. Metrics such as Facebook followers, likes', ‘shares’ and posts, Google reviews, traffic on ‘Instagram’ and ‘Twitter’ are but a few examples of critical engagement points and search criteria needed for business to grow, limit market retraction or in fact survive as they potentially are seeing their business revenues cannibalized in an online consumer world. The need to manage Google reviews, a key indicator in Google's search algorithm, is critical.

Online reviews and customer feedback is very important to all businesses. As a prospective customer, positive reviews may craft expectations, provide credibility, and instil confidence in making a purchase. Conversely, negative reviews may cause customers to shop elsewhere or buy different products. A retailer is always trying to improve their customer's experience. However obtaining the opinions of customers of brick and mortar retailers has continuously proved difficult to accomplish.

Many businesses are currently seeking customer feedback through online surveys. However, as a customer it is easy to forget about a survey on a receipt or not have enough buy-in to follow through to go online to complete the survey. To overcome this problem, it is common to see something along the lines of “Fill out this survey online for a chance to win $1000” or “Fill out this survey online to receive a free Dilly Bar” at the bottom of the receipt. This is done by numerous companies, though the participation of those online surveys is in the <1% range. Furthermore, it has been found that the data currently obtained from online surveys is skewed by the participation of two types of customers. Customers who have had a negative experience will take the time to provide their negative feedback. Customers who like to win prizes or receive free merchandize will take the time to fill out a survey.

### SUMMARY

According to one aspect, there is provided a method for generating social media engagement. The method involves placing at a brick and mortar business a computing device with a customer interface. Upon a triggering event, the computing device prompts a customer using the customer interface to complete a satisfaction survey. When the customer's interaction with the satisfaction survey meets a predetermined threshold, which is indicative of satisfaction, the computing device prompting the customer to post to social media and directing the customer to a URL with their interaction with the satisfaction survey pre-populating a social media post.

According to another aspect there is provided a system for generating social media engagement. The system consists of a computing device with a customer interface positioned in situ in a brick and mortar business. The computing device is programmed to prompt a customer using the customer interface to complete a satisfaction survey and, upon the customer completing the satisfaction survey, prompt the customer to post to social media and directing the customer to a URL with their interaction with the satisfaction survey pre-populating a social media post.

The description which follows will provide more detail on the method and the system. Preliminary field trials of the method and system have resulted in participation in the satisfaction survey and favourable social media posts increasing from less than 1% to over 10%. This is a huge improvement. It is believed that as customers become familiar with the method and the system that participation rates will further increase.

Whenever customers are asked to provide their feedback and post their feedback online to social media, there is always a risk that the customer will be dissatisfied with their shopping experience and will post a negative review. Even better result may be obtained by having the computing device send a contemporaneous alert to an employee of the brick and mortar business before posting occurs when the customer's interaction with the satisfaction survey fails to meet a predetermined threshold, which is indicative of dissatisfaction.

By prompt intervention of by an employee with customer relations skills, the source of the customer's satisfaction can be addressed before the satisfaction survey result have been posted. Ideally, this will enable the customer to redo the satisfaction survey and prevent any negative posts. However, the alert for employee intervention will, at minimum, result in the customer admitting that the business was responsive to the customer's concerns. It is to be noted that an automated posting does not occur in case of dissatisfaction, for the very reason that the method and the system will endeavour to provide time for employee intervention.

As will hereinafter be described, there are ways which the method and system can be streamlined to make it easier for the customer and take less time. For example, a loyalty card could have an associated social media profile for the customer. Upon a customer scanning their card into the customer interface, allowing them to reap the associated rewards of the loyalty or rewards card, they are provided an opportunity to complete a review and that review is posted immediately, provided conditions are met, from the computing device to a social media post from the customer's associated social media account.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a flow diagram of a method for generating social media engagement

FIG. 2 is a front elevation view of a system for generating social media engagement in accordance with the method of FIG. 1.

FIG. 3 is a rear elevation view of the system illustrated in FIG. 2.

### DETAILED DESCRIPTION

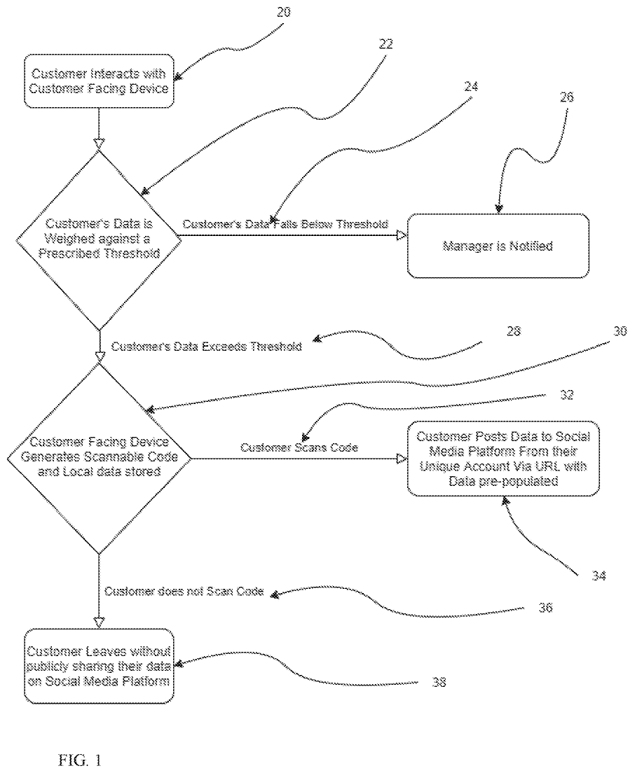

A method and system for generating social media engagement now be described with reference to FIG. 1 through FIG. 3.

### Method:

Referring to FIG. 1, the overview of the general flow of interaction and result of a customer with the out of home social media engagement system. 20 shows the initial step that every customer will begin with, when they first engage with the customer interface. This step presents them with questions to provide answers to. 22 shows that once the data is collected from it is compared against a prescribed threshold.

24 shows that should the data value fall below the threshold, the system can be configured to either automatically notify a manager or present the customer with the option to call for a manager. 26 demonstrates a potential result of the system wherein a manager has been notified either automatically or at the request of a customer. If there is mild dissatisfaction, the computing device is programmed to send a direct message to the customer's personal electronic device indicating that their next interaction will be a better experience and tagging the customer account for preferential treatment. If there is strong dissatisfaction, the computing device is programmed to send a direct message to the customer's personal electronic device providing a financial loyalty retention incentive, such as coupons or loyalty points.

28 continues the interaction for when the customer's data has exceeded the prescribed threshold and further engagement is suggested. The system provides the customer with a scannable code, such as a QR code) and logs the local data to the system as shown by 30. When the customer makes the decision to scan the code with their personal electronic device, 32, it will lead them to 34 where the system takes them via URL to a page with the data they have entered into the customer facing device is pre-loaded into a social media form that allows them to post their from their unique social media account.

36 shows that when a customer does not choose to scan the code, this leads to 38 where a customer leaves without uploading any public data from their unique social media account, though the system has still collected data from the user and conceivably could be posted anonymously.

Every interaction with the customer provides a further opportunity to collect customer feedback and, when the interaction with the customer has been positive, social media engagement. Retail stores have electronic directories that customers can access to obtain more information about a product that they are considering purchasing. Retail stores have systems for contacting sales associates to allow access to products that are kept in locked display case for security purposes or bulky products that are kept in adjoining warehouse space in order to preserve limited floor display space.

The system can track the time it takes from a contact by a customer with an electronic directory or sales associate to an actual purchase. Standards can be set as to how much time one would expect from such contact to purchase. If the time from contact to purchase is less than anticipated standards, one can reasonably expect a satisfied customer and send a notification prompting the customer to complete a customer satisfaction survey through their personal computing device. This will engage customers while they are in a contented state. The system is then able to capture positive reviews for the retailer that may otherwise would have been missed.

Conversely, if the time from contact to purchase is greater than anticipated standards, this may be an indication of a dissatisfied customer. If the system detects that the customer has had an arbitrarily long experience, the system notifies the customer on their personal computing device that the brick and mortar retailer will ensure that the customer's experience next time will be better. The system could conceivably advance that customer through service queues faster upon their next visit and indicate to staff that the customer had a negative experience during their last visit and every effort should be made to improve the service on this visit.

If after interaction, the server will be aware if a purchase does not subsequently occur. If the system identifies that the customer has abandoned their purchase, for example if they left an electronic directory without purchasing or asked for store staff to retrieve an item from the warehouse but they ultimately did not purchase the item, the system could conceivably contact the customer, to understand why the customer left without purchasing their items. This would provide better insight for the retailer as to why they lost a sale and allow the retailer to risk mitigate should it be found that the customer had had a negative experience.

### Structure and Relationship of Parts of System

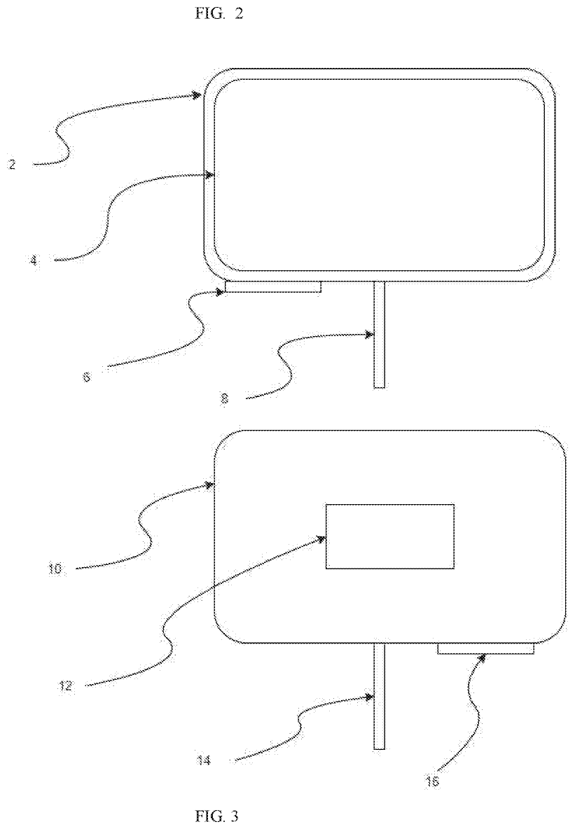

Referring to FIG. 2 and FIG. 3, the computing device with customer interface is illustrated. Referring to FIG. 2, a front side 2 of the computing device is show. A touch screen 4 is used as a customer interface for displaying the interaction interface to the customer. An optional scanner 6 is used to read loyalty card data presented by the customer in select circumstances. A cable bundle 8 is shown that includes an internet connection cable 8 (should the device not be connected to the internet via Wi-Fi or any other method), the security cable, and power cable bundle. Referring to FIG. 3, a back side 10 of the computing device is shown. There is a mounting bracket attachment point 12 and a back side 14 of the cable bundle of 8.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method for generating social media engagement, comprising:
providing a brick and mortar business with a computing device with a customer interface, upon a triggering event occurring the computing device prompting a customer using the customer interface to complete a satisfaction survey; and
when the customer's interaction with the satisfaction survey meets a predetermined threshold, which is indicative of satisfaction, the computing device prompting the customer to post to social media and directing the customer to a URL with their interaction with the satisfaction survey pre-populating a social media post.

2. The method of claim 1, wherein the customer interface is positioned at the checkout of the brick and mortar business and the triggering event is a purchase.

3. The method of claim 1, wherein the customer interface is an electronic directory accessible for instore shoppers of the brick and mortar business and the triggering event is a search inquiry for information on a product.

4. The method of claim 1, wherein the customer interface is an electronic call system for seeking assistance from a sales associate and the triggering event is a request to access a product than is in a warehouse or locked display case.

5. The method of claim 1, wherein the computing device sends a code to the customer's personal electronic device, the code directing the customer to the URL via the customer's personal electronic device with the customer's interaction with the satisfaction survey pre-populating the social media post from a unique social media account of the customer.

6. The method of claim 1, wherein the computing device sends a contemporaneous alert to an employee of the brick and mortar business, before posting occurs, when the customer's interaction with the satisfaction survey fails to meet a predetermined threshold, which is indicative of dissatisfaction.

7. The method of claim 5, wherein the transmission of the URL to the customer's personal electronic device is facilitated by NFC, Bluetooth, or other Radio protocols.

8. The method of claim 1, wherein the customer interface has one or more of a scanning interface, electrically reading, or radio interface allowing the customer interface to intake data from the customer.

9. The method of claim 5, wherein the transmission of the URL to the customer's personal electronic device is facilitated through optical means.

10. The method of claim 1, wherein the customer is directed to the URL with their interaction with the satisfaction survey pre-populating the social media post upon the computing device reading a customer's loyalty or rewards card, the social media post being posted from a unique social media account of the customer.

11. The method of claim 1, wherein the computing device tracks the time it takes from an initial customer interaction with an electronic directory or electronic call system for seeking assistance from a sales associate to purchase.

12. The method of claim 11, wherein the computing device is programmed to send a notification prompting the customer to complete a customer satisfaction survey through their personal computing device, if the time from the initial customer contact to purchase is less than pre-set standards.

13. The method of claim 11, wherein the computing device is programmed to send a notification offering loyalty rewards if the time from the initial customer contact to purchase is greater than pre-set standards.

14. A system for generating social media engagement, comprising:
a computing device with a customer interface positioned in situ in a brick and mortar business, the computing device being programmed to:
prompt a customer using the customer interface to complete a satisfaction survey;
when the customer's interaction with the satisfaction survey meets a predetermined threshold, which is indicative of satisfaction, prompt the customer to post to social media and direct the customer to a URL with their interaction with the satisfaction survey pre-populating a social media post.

15. The system of claim 14, wherein the computing device is programmed to generate a code and the code to the customer's personal electronic device, the code directing the customer to the URL via the customer's personal electronic device.

16. The system of claim 14, wherein the computing device is programmed to sends a contemporaneous alert to an employee of the brick and mortar business, before posting occurs, when the customer's interaction with the satisfaction survey fails to meet a predetermined threshold, which is indicative of dissatisfaction.

17. The system of claim 14, wherein the computing device is programmed to send a direct message to the customer's personal electronic device indicating that their next interaction will be a better experience and tagging the customer account for preferential treatment.

18. The system of claim 15, wherein he computing device is programmed to send a direct message to the customer's personal electronic device providing a financial loyalty retention incentive.

19. The system of claim 15, wherein computing device has transmission capability and the transmission of the URL to the customer's personal electronic device is facilitated by NFC, Bluetooth, or other Radio protocols.

20. The system of claim 14, wherein the customer interface has one or more of a scanning interface, electrically reading, or Radio interface allowing the customer interface to intake data from the customer.

21. The system of claim 15, wherein the transmission of the URL to the customer's personal electronic device is facilitated through optical means.

22. The system of claim 14, wherein the computing device prompts the customer to scan the customer's loyalty or rewards card upon completion of the satisfaction survey and the customer is directed to the URL with their interaction with the satisfaction survey pre-populating the social media post upon the computing device reading a customer's loyalty or rewards card, the social media post being posted from a unique social media account of the customer.
